(19) United States
(12) Patent Application Publication
(10) Pub. No.: US 2014/0083963 A1
(43) Pub. Date: Mar. 27, 2014

(54) Lawn Mower Storage Device with Stair Step Storage Area

(71) Applicants: Janet Wyner, Vero Beach, FL (US); Ryan McGinnis, Lansing, IL (US)

(72) Inventors: Janet Wyner, Vero Beach, FL (US); Ryan McGinnis, Lansing, IL (US)

(21) Appl. No.: 13/910,561

(22) Filed: Jun. 5, 2013

Related U.S. Application Data
(60) Provisional application No. 61/706,473, filed on Sep. 27, 2012.

(51) Int. Cl. B25H 3/04; A47B 81/00

(52) U.S. Cl. CPC B25H 3/04; A47B 81/00
USPC 211/134

(57) ABSTRACT

A container for storing various yard equipment items is provided. The container includes an open volume for receiving a lawn mower, an open rear end for inserting and removing the lawn mower, a pair of sidewalls, an open bottom, and a top wall including several risers and treads. The risers and treads provide the top wall with a stair step configuration. The stair steps enable the housing to match the contours of the yard equipment contained therein, and additionally provide storage space on the top of the housing for storing a plurality of items. The yard equipment can be inserted into and removed from the container without disturbing the items stored on the steps.

### CROSS REFERENCE TO RELATED APPLICATION

This application claims the benefit of U.S. Provisional Application No. 61/706,473, filed on Sep. 27, 2012, entitled “Lawnmower Caddy.” The above identified patent application is herein incorporated by reference in its entirety to provide continuity of disclosure.

### BACKGROUND OF THE INVENTION

### Field of the Invention

The present invention relates to yard equipment storage devices. More particularly, it pertains to a storage device for storing irregularly shaped yard equipment, such as a lawn mower or snow blower.

Yard power equipment, such as lawn mowers and snow blowers, require significant amounts of storage space when not in use. As can be appreciated, lawn mowers are generally used in the summer and in part of the spring and fall in most temperate climate locations, while snow blowers generally find use only in the winter. These devices require a temporary storage location between uses, and a long-term storage solution between seasons.

The difficulty encountered with storing lawn mowers and snow blowers relates to the size of their footprint and their irregular shape. These devices require significant amounts of floor space, and are difficult to store overhead due to their weight. Additionally, the irregular shape of conventional lawn mowers and snow blowers makes storing items on top of them difficult. Users may attempt to balance items on the top of these devices; however, objects laid on top are prone to falling and susceptible to damage. If a user is able to balance items on top of these devices, it can take a considerable amount of time to remove all of the items stored thereon when use of the device is required.

Conventional solutions for storing yard equipment include placing a protective cover over the device when not in use. These covers, however, can be difficult to properly install, and do not provide a storage area for the top of the lawn mower or snow blower. The present invention overcomes the problems inherent in yard equipment covers by providing a container that is designed for placement over lawn mowers, snow blowers, and other outdoor accessories. The device comprises a housing having an internal volume that fits over the top of a walk-behind lawn mower or snow blower. The housing includes an open volume for receiving a lawn mower, an open rear end for inserting and removing the lawn mower, a pair of sidewalls, an open bottom, and a top wall including several risers and treads. The risers and treads provide the top wall with a stair step configuration that can be used for storing items thereon. The yard equipment can be inserted into and removed from the container without disturbing the items stored on the steps. The device provides a convenient storage location for irregularly shaped yard equipment, and provides a storage space above the equipment for storing a variety of items in a location that would normally be unusable due to the shape of the lawn mower.

### DESCRIPTION OF THE PRIOR ART

Devices have been disclosed in the prior art that relate to yard equipment storage devices. These include devices that have been patented and published in patent application publications. These devices generally relate to containers for housing yard equipment. The following is a list of devices deemed most relevant to the present disclosure, which are herein described for the purposes of highlighting and differentiating the unique aspects of the present invention, and further highlighting the drawbacks existing in the prior art.

Specifically, Leon, U.S. Pat. No. 7,736,103 discloses a lawn mower cover that is designed to store and secure a lawn mower when not in use. The device includes a container for receiving the lawn mower. The container has an open end to permit insertion of the lawn mower. The container also includes a handle attached thereto that can be grasped by a user for moving the container. The device further includes a door that permits access to the interior of the container, and a plurality of wheels that roll along a support surface to facilitate relocation of the container. The Leon device discloses a container with a top, a bottom, four sidewalls, and a pair of wheels. The present invention includes an open volume for receiving a lawn mower, an open rear end for inserting and removing the lawn mower, a pair of sidewalls, an open bottom, and a top wall including several risers and treads. The present invention can be placed over top of yard equipment, remains in a static location, and provides a storage space above the equipment for storing a variety of items.

McCarthy, U.S. Pat. No. 6,332,554 discloses a storage box that can receive a lawn mower or similar piece of yard equipment. The device includes a rectangular bottom, a rear wall, a front wall, a first end wall closing one end of the box, and a second end wall hingedly attached to the front and rear walls for opening and closing the box. The second end wall opens to allow a user to store a piece of yard equipment within the box. Similar to the Leon patent, the '554 device discloses a container with a top, a bottom, and four sidewalls. The '554 device does not include an open bottom and rear end, and does not include a stair step on the top thereof for use as a storage space.

Additionally, Robbins, U.S. Pat. No. 4,894,961 discloses a container for enclosing a walk-behind type lawn mower. The container includes a housing having a hollow interior for receiving the lawn mower, and an opening for allowing the lawn mower to be pushed into and pulled from the interior. The device further includes a door for opening and closing the container. The Robbins device provides a container with a hingedly attached door for storing a lawn mower between uses. While the device tapers to fit the contours of the lawn mower, it does not include stair steps on the top, an open bottom, or an open rear end.

Anderson, U.S. Pat. No. 4,673,227 discloses an enclosure cabinet for storing a lawn mower or a similar piece of yard equipment that includes a handle. The device comprises a container adapted to fit the body of the lawn mower, and a secondary covering that secures on the handle of the lawn mower. The secondary covering latches onto the container for inserting and removing the lawn mower therefrom. The '227 device is shaped to fit the irregular contours of a lawn mower, and does not provide storage space above the device.

Finally, Smith, U.S. Pat. No. 3,087,585 discloses a container for a lawn mower, comprising a curved top, a pair of flat sidewalls, and an opening for accepting the lawn mower. The device further includes an opening for the lawn mower handle. The Smith device protects only the body of the lawn mower, and includes a curved top that prevents items from being stored thereon. The present invention covers the body of the lawn mower as well as the handle, and further includes a storage location on the top.

The devices disclosed in the prior art provide containers for storing a lawn mower or snow blower when not in use. The devices generally include a top, a bottom, and four sidewalls. The prior art devices create a storage box with a door for storing the yard equipment between uses. While these devices protect the yard equipment, they do not provide a means of storing items in the space above the lawn mower. The present invention provides a housing with stair steps built into the top. The stair steps can be used to store various items thereon, and increase the amount of storage space available directly over the yard equipment. Additionally, the yard equipment can be inserted into and removed from the container without affecting the devices stored on the steps. In light of the prior art and the disclosed elements of the present invention, it is submitted that the present invention substantially diverges in design elements from the prior art. Consequently, it is clear that the present invention is not described by the art and that a need exists for a container for housing yard equipment. In this regard, the instant invention substantially fulfills these needs.

### SUMMARY OF THE INVENTION

In view of the foregoing disadvantages inherent in the known types of containers for housing yard equipment now present in the prior art, the present invention provides a new container for housing yard equipment wherein the same can be utilized for providing convenience for the user when storing yard equipment between uses, and for providing storage space above the container.

It is therefore an object of the present invention to provide a new and improved container for housing yard equipment that has all of the advantages of the prior art and none of the disadvantages.

It is another object of the present invention to provide a new and improved container for housing yard equipment that includes a housing with an open volume for receiving a lawn mower, snow blower, or other article of yard equipment.

Another object of the present invention is to provide a new and improved container for housing yard equipment that includes a pair of sidewalls, an open bottom, and a top wall with a plurality of risers and treads that create a stair step configuration.

Another object of the present invention is to provide a new and improved container for housing yard equipment that includes storage space on the stair steps for storing a plurality of items.

Yet another object of the present invention is to provide a new and improved container for housing yard equipment that includes an open bottom, which enables the housing to be placed over top of the yard equipment, thereby providing protection on all sides of the equipment.

Another object of the present invention is to provide a new and improved container for housing yard equipment that includes dimensions that can accommodate a lawn mower, snow blower, or other article of yard equipment.

A final object of the present invention is to provide a container for housing yard equipment that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and the manner in which it may be made and used may be better understood after a review of the following description, taken in connection with the accompanying drawings wherein like numeral annotations are provided throughout.

FIG. 1 is a rear perspective view of the present invention with a push lawn mower stored within the housing.

FIG. 2 is a cross-sectional view of the present invention, with a lawn mower stored within the open volume and a plurality of items stored on the stair steps.

FIG. 3 is a perspective view of the present invention, with a lawn mower stored within the open volume and a plurality of items stored on the stair steps.

FIG. 4 is a side view of the present invention, with a snow blower stored within the open volume of the housing.

### DETAILED DESCRIPTION OF THE INVENTION

Reference is made herein to the attached drawings. Like reference numerals are used throughout the drawings to depict like or similar elements of the housing. For the purposes of presenting a brief and clear description of the present invention, the preferred embodiment will be discussed as used for storing articles of yard equipment within the housing, and for storing various items on the stair steps. The figures are intended for representative purposes only and should not be considered to be limiting in any respect.

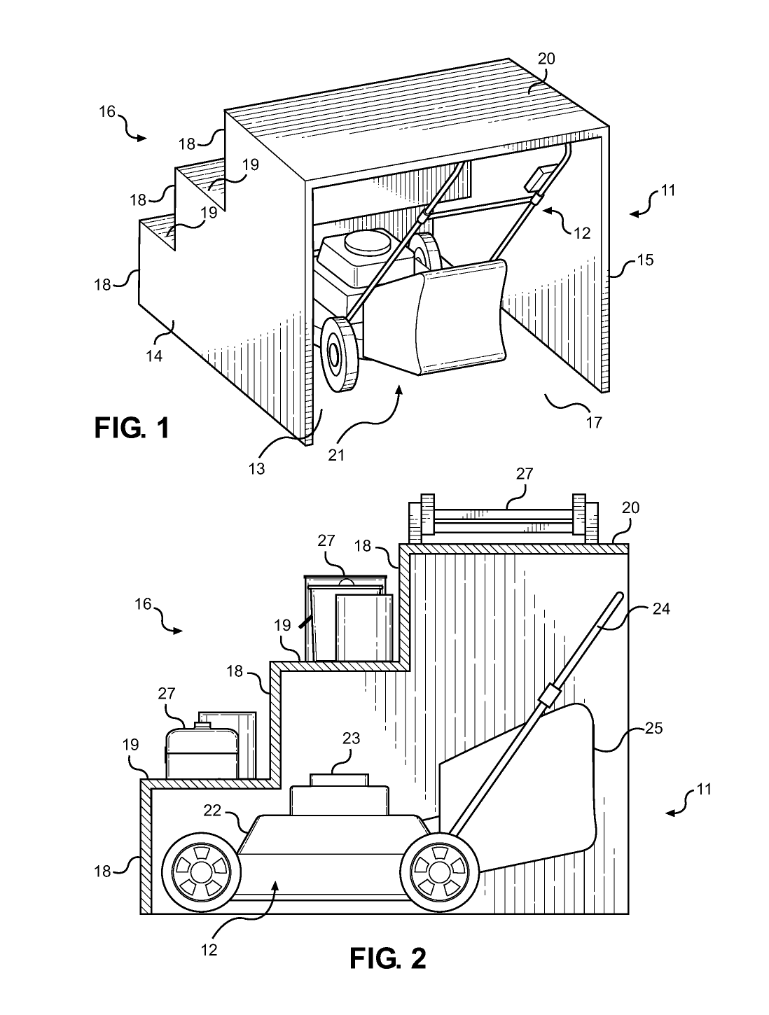

Referring now to FIG. 1, there is shown a rear perspective view of the present invention with a push lawn mower stored within the housing. The device comprises a housing 11 with an open volume 21 for receiving an article of yard equipment, such as a lawn mower 12. The housing protects the lawn mower and provides a storage space above it. The housing has an open rear end 13 for inserting an article of lawn equipment into the open volume. The housing further includes a pair of sidewalls 14, 15, a top wall 16, and an open bottom 17. The top wall includes a plurality of risers 18 and treads 19, providing the top wall with a stair step configuration. The uppermost portion of the top wall has a platform 20 that is larger than the treads. The housing preferably includes dimensions that are slightly larger than the lawn mower to be stored within the open volume, thereby ensuring that the lawn mower is completely covered.

Referring now to FIG. 2, there is shown a cross-sectional side view of the present invention, with a lawn mower stored within the open volume and a plurality of items stored on the stair steps. The risers 18 and treads 19 provide the top wall 16 with a lower section positioned over the lawn mower deck 22 and motor 23. The risers and treads provide a taller opening within the housing 11, moving from the lowermost tread towards the open rear end 13, which accommodates the handle 24 and collection bag 25. The stair step configuration of the top wall provides the housing with dimensions that match the contours of the yard equipment contained therein. The contoured shape of the housing prevents wasted storage space above the lawn mower 12, allowing for better utilization of the available storage space in a garage or tool shed.

The stair steps additionally provide storage space on the top of the housing for storing a plurality of items 27. The treads provide a planar surface that is positioned horizontally with respect to the support surface the housing is placed upon. A user can place various items, such as tools, containers, or painting supplies on the treads for storage. The risers provide a vertical support to prevent the items placed on the housing from falling. Additionally, the platform 20 provides an enlarged storage area on the top of the housing for storing larger items that do not fit on the treads.

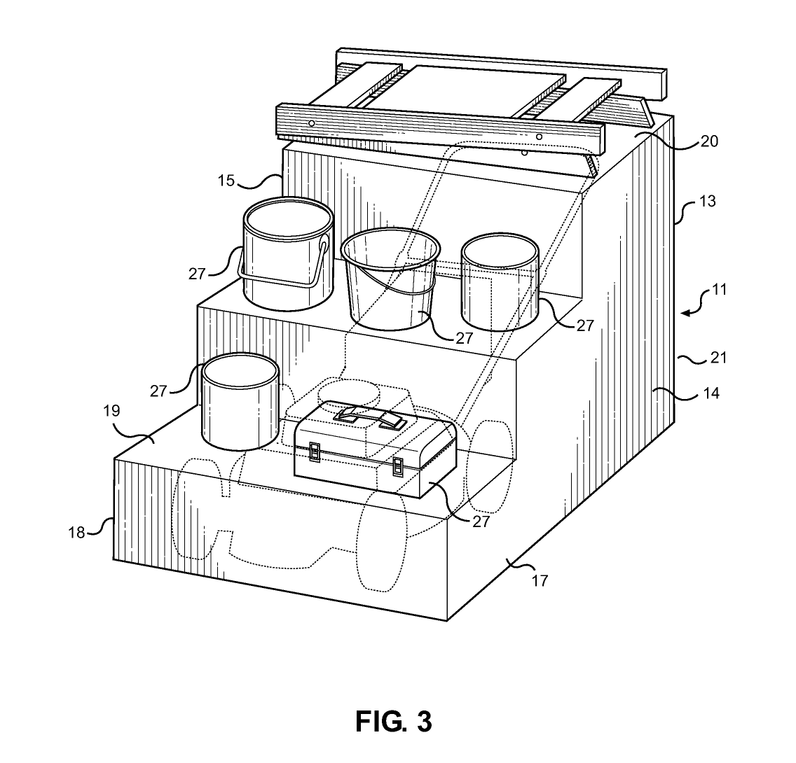

Referring now to FIG. 3, there is shown a perspective view of the present invention, with a lawn mower stored within the open volume and a plurality of items stored on the stair steps. In use, the housing 11 is positioned in a suitable location, such as in a garage, tool shed, or other area. The riser 18 and sidewalls 14, 15 enable the housing to be positioned against a vertical support surface, such as a wall. The housing is positioned to provide access to the open rear end 13, thereby enabling a user to insert and remove a lawn mower 12 from the open volume 21. Once the housing is positioned in a suitable location, the lawn mower is inserted through the open rear end and rolled into the housing. A variety of items 27 can be placed onto the treads 19 and platform 20 for storage. When use of the lawn mower is desired, the handle 24 is grasped and the lawn mower is rolled out from the open volume. The configuration of the housing enables insertion and removal of the lawn mower without interfering with the items stored on the treads and platform.

Alternatively, the lawn mower can be positioned in a suitable location, and the housing can be placed over top of the lawn mower for storage. The open bottom 17 enables the housing to be lifted over top of the lawn mower and positioned for storage. The open bottom enables a user to position the housing so that the open rear end abuts a vertical support surface, thereby enclosing the lawn mower on all sides. Having the lawn mower enclosed on all sides is ideal for long-term storage, such as during the winter months when use of the lawn mower is not anticipated.

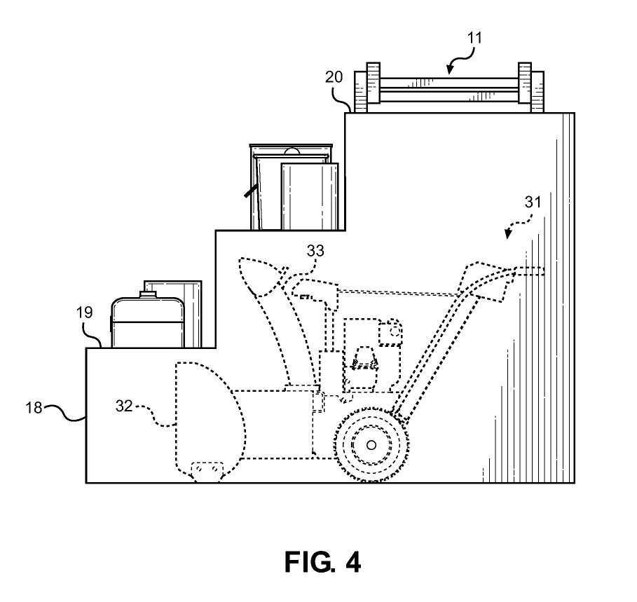

Referring now to FIG. 4, there is shown a side view of the present invention, with a snow blower stored within the open volume of the housing. The dimensions of the housing 11 can be altered for use for storing other types of yard equipment. As an example, the housing can store a conventional snow blower 31. To accommodate a snow blower, the proportions of the risers 18 and treads 19 may require alteration in order to accommodate the shroud 32 and chute 33. The height of the risers and the length of the treads can be increased to ensure complete coverage of the snow blower. The change in proportions ensures complete protection of the snow blower, while providing storage space on the treads and platform 20.

The housing can be constructed from a variety of materials, such as wood, plastic, metal, or another suitable material. The dimensions of the housing can be altered to accommodate the shape of various articles of yard equipment. The housing can additionally be fitted with storage hooks and racks, pegboards, drawers or high friction material on the treads and platform.

Overall, the present invention provides a device that affords protection to various articles of yard equipment, and additionally provides a means of storing various items in a location that would otherwise be unusable due to the shape of the equipment. The yard equipment can be inserted into and removed from the container without affecting the items stored on the housing. The stair steps increase the amount of available storage space available over top of the yard equipment, which would otherwise be unusable due to the irregular shape of conventional lawn mowers and snow blowers. The housing can be positioned for easy access to the yard equipment, or stored with a vertical support providing coverage for all sides of the equipment. This ensures that the equipment is properly protected when being stored for extended periods of time.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An equipment storage container, comprising:
a housing having a pair of sidewalls, a top wall, an open rear end, and an open bottom forming an open volume adapted for storage of items therein;
said top wall having a plurality of risers and treads in a stair step configuration, said top wall treads adapted to support items thereon.

2. The device of claim 1, wherein said top wall further comprises an uppermost platform, said platform having a greater surface area than said treads.

3. The device of claim 1, wherein said risers and treads provide said top wall with a lower section positioned over a deck and motor of a lawn mower.

4. The device of claim 3, wherein said risers and treads provide a taller opening within said housing moving from the lowermost tread towards said open rear end for accommodating a handle and collection bag on a lawn mower.
